(19) United States
(12) Patent Application Publication
(10) Pub. No.: US 2015/0075853 A1
(43) Pub. Date: Mar. 19, 2015

(54) MULTILAYER CERAMIC ELECTRONIC COMPONENT EMBEDDED IN BOARD AND PRINTED CIRCUIT BOARD HAVING THE SAME

(71) Applicant: SAMSUNG ELECTRO-MECHANICS CO., LTD., Suwon (KR)

(72) Inventors: Hai Joon LEE, Suwon (KR); Doo Young KIM, Suwon (KR); Byoung Hwa LEE, Suwon (KR); Jin Man JUNG, Suwon (KR)

(73) Assignee: SAMSUNG ELECTRO-MECHANICS CO., LTD., Suwon (KR)

(21) Appl. No.: 14/135,308

(22) Filed: Dec. 19, 2013

(30) Foreign Application Priority Data
Sep. 16, 2013 (KR) 10-2013-0111345

(51) Int. Cl. H01G 2/06; H01G 4/30

(52) U.S. Cl. CPC H01G 2/06; H01G 4/30
USPC 174/260; 361/301.4

(57) ABSTRACT

There is provided a multilayer ceramic electronic component embedded in a board including: a ceramic body including dielectric layers; an active layer including a plurality of first and second internal electrodes, having the dielectric layer therebetween, to thereby form capacitance; upper and lower cover layers formed in upper and lower portions of the active layer; and first and second external electrodes formed in both ends of the ceramic body, wherein the first external electrode includes a first base electrode and a first terminal electrode formed on the first base electrode, the second external electrode includes a second base electrode and a second terminal electrode formed on the second base electrode, and in the case that a thickness of the upper cover layer is tc1 and a thickness of the lower cover layer is tc2, 0.10≦tc1/tc2≦1.00 is satisfied.

### CROSS-REFERENCE TO RELATED APPLICATION

This application claims the benefit of Korean Patent Application No. 10-2013-0111345 filed on Sep. 16, 2013, with the Korean Intellectual Property Office, the disclosure of which is incorporated herein by reference.

### BACKGROUND

The present disclosure relates to a multilayer ceramic electronic component embedded in a board and a printed circuit board having the same embedded therein.

In accordance with high densification and high integration of electronic circuit, passive elements mounted on a printed circuit board have decreased mounting areas, such that an effort in achieving a component embedded in the board, for example, embedded device has been conducted in order to overcome the decreased mounting area. In particular, various methods of embedding a multilayer ceramic electronic component used as a capacitive component in the board have been suggested.

As one method of embedding the multilayer ceramic electronic component in the board, there is a method in which a board material itself is used as a dielectric material for a multilayer ceramic electronic component and a copper wiring, and the like, are used as an electrode for a multilayer ceramic electronic component. In addition, as another method of achieving a multilayer ceramic electronic component embedded in a board, there are a method of forming a polymer sheet having high dielectric constant or a thin film dielectric in the board to manufacture the multilayer ceramic electronic component embedded in the board, and a method of embedding the multilayer ceramic electronic component in the board, and the like.

In general, the multilayer ceramic electronic component includes a plurality of dielectric layers formed of a ceramic material and internal electrode inserted between the plurality of dielectric layers. The multilayer ceramic electronic component is disposed in the board, such that the multilayer ceramic electronic component embedded in the board having high capacitance may be achieved.

In order to manufacture the printed circuit board having the multilayer ceramic electronic component embedded in the board, after the multilayer ceramic electronic component is inserted into a core board, a laser beam should be used to drill via holes in the upper multilayered plate and a lower multilayered plate in order to connect board wirings to the external electrodes of the multilayer ceramic electronic component. The laser beam processing is a factor causing the manufacturing cost of the printed circuit board to be significantly increased.

Meanwhile, since the multilayer ceramic electronic component embedded in the board is required to be embedded in the core of the board, a nickel/tin (Ni/Sn) plating layer is not required on the external electrode unlike general multilayer ceramic electronic component to be mounted on a surface of the board.

For example, since the external electrode of the multilayer ceramic electronic component embedded in the board is electrically connected to the circuit in the board through a via formed of a copper (Cu) material, a copper (Cu) layer instead of a nickel/tin (Ni/Sn) layer is required on the external electrode.

In general, the external electrode is mainly formed of copper (Cu), but includes a glass, such that at the time of performing a laser process in forming the via in the board, a component included in the glass absorbs a laser beam, whereby a processing depth of the via may not be adjusted.

Due to the reason as described above, the external electrode of the multilayer ceramic electronic component embedded in the board includes a copper (Cu) plating layer separately formed thereon.

Meanwhile, the multilayer ceramic electronic component embedded in the board is embedded in the printed circuit board used in a memory card, a PC main board, and various radio frequency (RF) modules, such that a size of a manufactured product may be significantly decreased as compared to a multilayer ceramic electronic component mounted on a board.

In addition, since the multilayer ceramic electronic component embedded in the board may be disposed to be significantly adjacent to an input terminal of an active element such a micro processor unit (MPU), interconnect inductance due to a length of an electrical wire may be decreased.

The decrease in the inductance of the multilayer ceramic electronic component embedded in the board is merely caused by the decrease in the interconnect inductance obtained due to a unique disposition relationship, for example, an embedded scheme, and an equivalent series inductance (ESL) of the multilayer ceramic electronic component itself still needs to be improved.

In general, in the multilayer ceramic electronic component embedded in the board, a current path in the multilayer ceramic electronic component needs to be shorten in order to decrease an ESL.

However, the external electrode of the multilayer ceramic electronic component embedded in the board includes the copper (Cu) plating layer separately formed thereon, thereby causing a problem in that a plating solution is infiltrated into the external electrode, such that it is not easy to shorten the current path in the multilayer ceramic electronic component.

In addition, since the external electrode of the multilayer ceramic electronic component embedded in the board has an extremely thin chip thickness, even though the current path is shorten, moisture resistance defect caused by infiltrating moisture into a part having a thin thickness of the external electrode and contacting the internal electrode may be frequently generated.

### RELATED ART DOCUMENT

(Patent Document 1) Korean Patent Laid-Open Publication No. 2006-0047733

### SUMMARY

An aspect of the present disclosure may provide a multilayer ceramic electronic component embedded in a board and a printed circuit board having the same.

According to an aspect of the present disclosure, a multilayer ceramic electronic component embedded in a board may include: a ceramic body including dielectric layers and having first and second main surfaces opposing each other, first and second side surfaces opposing each other, and first and second end surfaces opposing each other; an active layer including a plurality of first and second internal electrodes formed to be alternately exposed through both end surfaces of the ceramic body, having the dielectric layer therebetween, to thereby form capacitance; upper and lower cover layers formed in upper and lower portions of the active layer; and first and second external electrodes formed in both ends of the ceramic body, wherein the first external electrode includes a first base electrode and a first terminal electrode formed on the first base electrode, the second external electrode includes a second base electrode and a second terminal electrode formed on the second base electrode, and in the case that a thickness of the upper cover layer is tc1 and a thickness of the lower cover layer is tc2, 0.10≦tc1/tc2≦1.00 is satisfied.

In the case that a thickness of areas of the first and second base electrodes corresponding to a virtual line drawn in a length direction of the ceramic body from an uppermost internal electrode among the first and second internal electrodes is ta, 10 μm≦ta≦50 μm may be satisfied.

The first and second terminal electrodes may be formed of copper (Cu).

In the case that a thickness of the first and second terminal electrodes is tp, tp≧5 μm may be satisfied.

In the case that a surface roughness of the first and second terminal electrodes is Ra and a thickness of the first and second terminal electrodes is tp, 200 nm≦Ra≦tp may be satisfied.

The first and second terminal electrodes may be formed by a plating process.

In the case that a thickness of the ceramic body is ts, ts≦300 μm may be satisfied.

The ceramic body may further include a marking part formed thereon.

According to another aspect of the present disclosure, a printed circuit board having a multilayer ceramic electronic component embedded therein may include: an insulating board; and the multilayer ceramic electronic component embedded in the insulating board, including a ceramic body including dielectric layers and having first and second main surfaces opposing each other, first and second side surfaces opposing each other, and first and second end surfaces opposing each other; an active layer including a plurality of first and second internal electrodes formed to be alternately exposed through both end surfaces of the ceramic body, having the dielectric layer therebetween, to thereby form capacitance; upper and lower cover layers formed in upper and lower portions of the active layer; and first and second external electrodes formed in both ends of the ceramic body, wherein the first external electrode includes a first base electrode and a first terminal electrode formed on the first base electrode, the second external electrode includes a second base electrode and a second terminal electrode formed on the second base electrode, and in the case that a thickness of the upper cover layer is tc1 and a thickness of the lower cover layer is tc2, 0.10≦tc1/tc2≦1.00 is satisfied.

In the case that a thickness of areas of the first and second base electrodes corresponding to a virtual line drawn in a length direction of the ceramic body from an uppermost internal electrode among the first and second internal electrodes is ta, 10 μm≦ta≦50 μm may be satisfied.

The first and second terminal electrodes may be formed of copper (Cu).

In the case that a thickness of the first and second terminal electrodes is tp, tp≧5 μm may be satisfied.

In the case that a surface roughness of the first and second terminal electrodes is Ra and a thickness of the first and second terminal electrodes is tp, 200 nm≦Ra≦tp may be satisfied.

The first and second terminal electrodes may be formed by a plating process.

In the case that a thickness of the ceramic body is ts, ts≦300 μm may be satisfied.

The ceramic body may further include a marking part formed thereon.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view showing a multilayer ceramic electronic component embedded in a board according to an exemplary embodiment of the present disclosure;

FIG. 2 is a cross-sectional view taken along line X-X′ of FIG. 1;

FIG. 3 is an enlarged view of region A of FIG. 2; and

FIG. 4 is a cross-sectional view showing a printed circuit board having a multilayer ceramic electronic component embedded therein according to an exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Multilayer Ceramic Electronic Component Embedded in Board

Exemplary embodiments of the present disclosure will now be described with reference to the accompanying drawings.

FIG. 1 is a perspective view showing a multilayer ceramic electronic component embedded in a board according to an exemplary embodiment of the present disclosure.

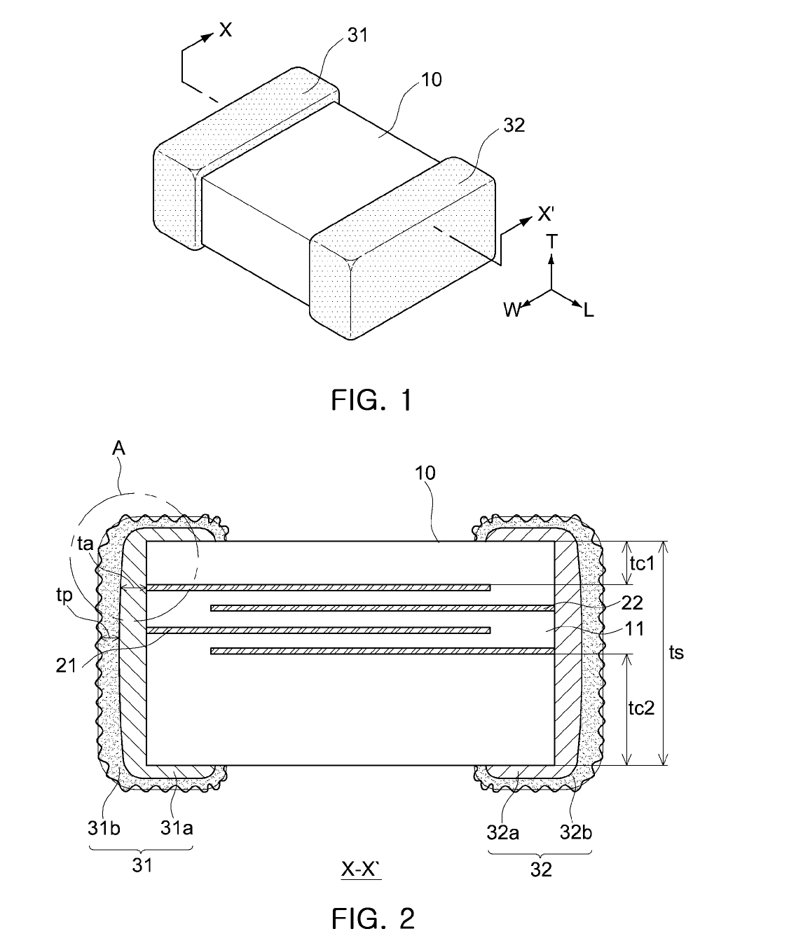

FIG. 2 is a cross-sectional view taken along line X-X′ of FIG. 1.

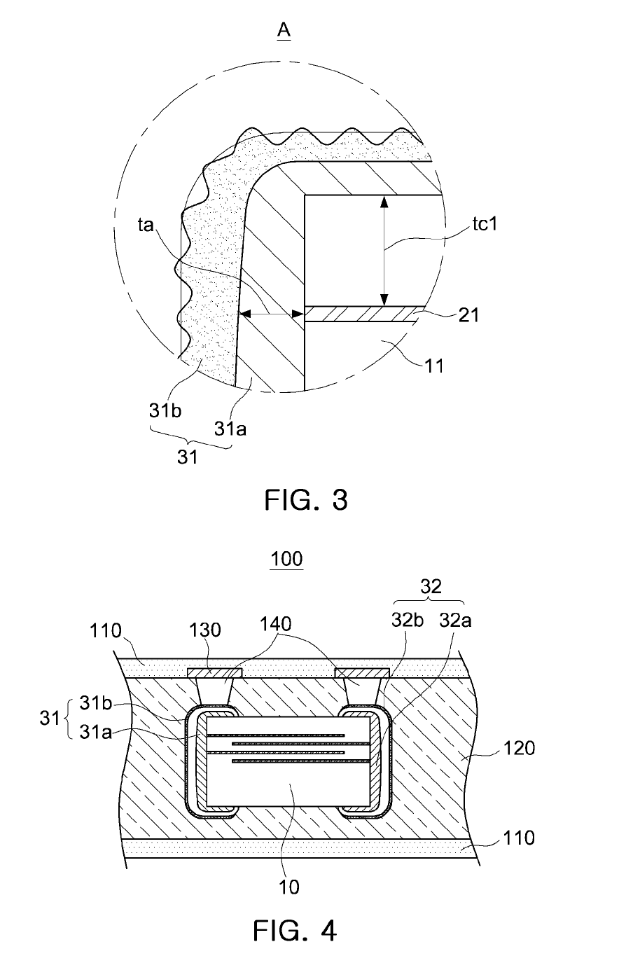

FIG. 3 is an enlarged view of region A of FIG. 2.

Referring to FIGS. 1 to 3, a multilayer ceramic electronic component embedded in a board according to an exemplary embodiment of the present disclosure may include: a ceramic body 10 including dielectric layers 11 and having first and second main surfaces opposing each other, first and second side surfaces opposing each other, and first and second end surfaces opposing each other; an active layer including a plurality of first and second internal electrodes 21 and 22 formed to be alternately exposed through both end surfaces of the ceramic body 10, having the dielectric layer 11 therebetween, to thereby form capacitance; upper and lower cover layers formed on upper and lower portions of the active layer; and first and second external electrodes 31 and 32 formed on both ends of the ceramic body 10, wherein the first external electrode 31 includes a first base electrode 31a and a first terminal electrode 31b formed on the first base electrode 31a, the second external electrode 32 includes a second base electrode 32a and a second terminal electrode 32b formed on the second base electrode 32a, and in the case that a thickness of the upper cover layer is tc1 and a thickness of the lower cover layer is tc2, 0.10≦tc1/tc2≦1.00 is satisfied.

Hereinafter, the multilayer ceramic electronic component according to the exemplary embodiment of the present disclosure, in particular, a multilayer ceramic capacitor will be described. However, the present disclosure is not limited thereto.

In the multilayer ceramic capacitor according to the exemplary embodiment of the present disclosure, a ‘length direction’ refers to an ‘L’ direction of FIG. 1, a ‘width direction’ refers to a ‘W’ direction of FIG. 1, and a ‘thickness direction’ refers to a ‘T’ direction of FIG. 1. Here, the ‘thickness direction’ may be the same as a direction in which the dielectric layers are stacked, a ‘stacking direction’.

In the exemplary embodiment of the present disclosure, the ceramic body 10 may have a substantially hexahedral shape, but is not limited thereto.

In the exemplary embodiment of the present disclosure, the ceramic body 10 may have the first and second main surfaces opposing each other, the first and second side surfaces opposing each other, and the first and second end surfaces opposing each other, wherein the first and second main surfaces may refer to upper and lower surfaces of the ceramic body 10.

The ceramic body 10 may have thickness is of 300 μm or less.

The ceramic body 10 may be manufactured to have the thickness ts of 300 μm or less so as to be suitable for the multilayer ceramic capacitor embedded in a board.

In addition, the thickness ts of the ceramic body 10 may be a distance between the first main surface and the second main surface.

According to the exemplary embodiment of the present disclosure, a raw material forming the dielectric layer 11 is not particularly limited as long as sufficient capacitance may be obtained, but maybe, for example, a barium titanate (BaTiO₃) powder.

A material forming the dielectric layer 11 may be obtained by adding various ceramic additives, organic solvents, plasticizers, binders, dispersing agents, and the like, to a powder such as a barium titanate (BaTiO₃) powder, or the like, according to a purpose of the present disclosure.

An average particle size of ceramic powder used in forming the dielectric layer 11 is not particularly limited. The average particle size thereof may be controlled to be, for example, 400 nm or less, as needed.

The ceramic body 10 may include an active layer, a part contributing to capacitance formation of the capacitor and may be configured as upper and lower cover layers formed on upper and lower portions of the active layer as upper and lower margin parts, respectively.

The active layer may be formed by repeatedly multilayering a plurality of first and second internal electrodes 21 and 22, having the dielectric layer 11 therebetween.

The upper and lower cover layers may have the same material and same configuration as those of the dielectric layer 11 except for not including the internal electrode therein.

The upper and lower cover layers may be formed by multilayering a single dielectric layer or two or more dielectric layers on upper and lower surfaces of the active layer in a thickness direction, respectively, and may basically serve to prevent the internal electrodes from being damaged due to physical or chemical stress.

In particular, since a copper (Cu) plating layer is separately formed on the external electrode in the case of the multilayer ceramic electronic component embedded in the board, the internal electrodes may be damaged due to infiltration of a plating solution.

In order to prevent the above-described problem, in the case of a general multilayer ceramic electronic component embedded in the board, thicknesses of upper and lower cover layers are relatively thick to prevent damage of the internal electrodes caused by infiltration of plating solution.

However, in the case in which the upper and lower cover layers have a relatively thick thickness, a current path in the multilayer ceramic electronic component embedded in the board is relatively long, so as not to be easy to decrease an equivalent series inductance (ESL).

According to the exemplary embodiment of the present disclosure, in the case that the thickness of the upper cover layer is tc1 and the thickness of the lower cover layer is tc2, 0.10≦tc1/tc2≦1.00 may be satisfied.

A ratio tc1/tc2 of the thickness tc1 of the upper cover layer to the thickness tc2 of the lower cover layer is adjusted to satisfy 0.10≦tc1/tc2≦1.00, such that the current path in the multilayer ceramic electronic component embedded in the board may be shorten to decrease an ESL.

For example, the thickness of the upper cover layer is less than that of the lower cover layer, such that the current path in the multilayer ceramic electronic component embedded in the board may be shorten.

As described above, the ratio tc1/tc2 of the thickness of the upper cover layer tc1 to the thickness of the lower cover layer tc2 is adjusted to satisfy 0.10≦tc1/tc2≦1.00, such that at the time of allowing the multilayer ceramic capacitor to be embedded in the board, a portion of the upper cover layer having a thinner thickness may be disposed to be adjacent to an application processor (AP), whereby the current path may be shorten to decrease an ESL.

For example, a position of the internal electrodes of the multilayer ceramic capacitor embedded in the board is adjacent to the AP, such that the current path may be shorten to decrease an ESL.

In a case in which the ratio tc1/tc2 of the thickness tc1 of the upper cover layer to the thickness tc2 of the lower cover layer is less than 0.10, since a difference between the thickness of the upper cover layer and the thickness of the lower cover layer is significant, warpage may be generated.

Meanwhile, in the case in which the ratio tc1/tc2 of the thickness tc1 of the upper cover layer to the thickness tc2 of the lower cover layer is more than 1.0, since a current path in the multilayer ceramic electronic component embedded in the board is relatively long, an ESL may not be decreased.

Meanwhile, the first and second internal electrodes 21 and 22, a pair of electrodes having different polarities, may be formed on the dielectric layer 11 by printing a conductive paste including a conductive metal to a predetermined thickness.

In addition, the first and second internal electrodes 21 and 22 may be formed to be alternately exposed through both end surfaces in a stacking direction of the dielectric layers 11, and be electrically insulated from each other by the dielectric layer 11 disposed therebetween.

For example, the first and second internal electrodes 21 and 22 may be electrically connected to the first and second external electrodes 31 and 32, respectively, through a portion in which the first and second internal electrodes 21 and 22 are alternately exposed to both end surfaces of the ceramic body 10.

Therefore, in the case in which a voltage is applied to the first and second external electrodes 31 and 32, electric charges are accumulated between the first and second internal electrodes 21 and 22 facing each other. Here, capacitance of the multilayer ceramic capacitor is in proportion to an area of a region in which the first and second internal electrodes 21 and 22 are overlapped with each other.

In addition, the conductive metal included in the conductive paste forming the first and second internal electrodes 21 and 22 may be nickel (Ni), copper (Cu), palladium (Pd), or alloys thereof, but the present disclosure is not limited thereto.

Further, a printing method of the conductive paste may include a screen printing method, a gravure printing method, or the like, but the present disclosure is not limited thereto.

According to the exemplary embodiment of the present disclosure, the first and second external electrodes 31 and 32 may be formed on both ends of the ceramic body 10.

The first external electrode 31 may include the first base electrode 31a electrically connected to the first internal electrode 21 and the first terminal electrode 31b formed on the first base electrode 31a.

In addition, the second external electrode 32 may include the second base electrode 32a electrically connected to the second internal electrode 22 and the second terminal electrode 32b formed on the second base electrode 32a.

Hereinafter, structures of the first and second external electrodes 31 and 32 will be described in detail.

The first and second base electrodes 31a and 32a may include the first conductive metal and glass.

In order to form capacitance, the first and second external electrodes 31 and 32 may be formed on both end surfaces of the ceramic body 10, and the first and second base electrodes 31a and 32a included in the first and second external electrodes 31 and 32 may be electrically connected to the first and second internal electrodes 21 and 22.

The first and second base electrodes 31a and 32a may be formed of the same conductive material as those of the first and second internal electrodes 21 and 22, and for example, may be formed of at least one first conductive metal selected from a group consisting of copper (Cu), silver (Ag), nickel (Ni), and alloys thereof. However, the present disclosure is not limited thereto.

The first and second base electrodes 31a and 32a may be formed by applying a conductive paste prepared by adding glass frit to a first conductive metal powder and performing a firing process.

According to the exemplary embodiment of the present disclosure, the first and second external electrodes 31 and 32 may include the first and second terminal electrodes 31b and 32b formed on the first and second base electrodes 31a and 32a.

The first and second terminal electrodes 31b and 32b may be formed of a second conductive metal.

The second conductive metal is not particularly limited, but may be copper (Cu).

In general, since the multilayer ceramic capacitor is mounted on the printed circuit board, a nickel/tin plating layer may be generally formed on the external electrode.

However, the multilayer ceramic capacitor according to the exemplary embodiment of the present disclosure may be a multilayer ceramic capacitor embedded in a board, but may not be mounted on a board, and the first external electrode 31 and the second external electrode 32 of the multilayer ceramic capacitor and a circuit of the board may be electrically connected to each other through a via formed of copper (Cu).

Therefore, according to the exemplary embodiment of the present disclosure, the first and second terminal electrodes 31b and 32b may be formed of copper (Cu) having good electrical connectivity with copper (Cu), the material of which the via in the board is formed.

Meanwhile, the first base electrode 31a and the second base electrode 32a are mainly formed of copper (Cu), but include glass, such that at the time of performing a laser process in forming the via in the board, a component included in the glass may absorb a laser beam, whereby a processing depth of the via may not be able to be adjusted.

Due to the reason as described above, the first and second terminal electrodes 31b and 32b of the multilayer ceramic electronic component embedded in the board may be formed of copper (Cu).

A method of forming the first and second terminal electrodes 31b and 32b is not particularly limited, but for example, may be formed by a plating process.

Therefore, after performing the firing process, since the first and second terminal electrodes 31b and 32b are only formed of copper (Cu) and do not include glass frit, at the time of performing a laser process in forming the via in the board, a component included in the glass may absorb a laser beam, whereby the above-described problem in which the processing depth of the via is not capable of being adjusted may not occur.

Meanwhile, according to the exemplary embodiment of the present disclosure, in the case that a thickness of a respective area of the first and second base electrodes 31a and 32a corresponding to a virtual line drawn in a length direction of the ceramic body 10 from the uppermost internal electrode among the first and second internal electrodes 21 and 22 is ta, 10 μm≦ta≦50 μm may be satisfied.

In order to shorten the current path in the multilayer ceramic electronic component embedded in the board to decrease an ESL as described above, the ratio tc1/tc2 of the thickness tc1 of the upper cover layer to the thickness tc2 of the lower cover layer may be adjusted to satisfy 0.10≦tc1/tc2≦1.00, such that moisture or a plating solution may be infiltrated into the external electrodes.

For example, as a thickness of the upper cover layer is decreased, a thickness of a respective area of the first and second base electrodes corresponding to the virtual line drawn in the length direction of the ceramic body from the uppermost internal electrode among the first and second internal electrodes is generally thin, such that moisture or a plating solution may be easily infiltrated into the electrodes.

However, according to the exemplary embodiment of the present disclosure, in the case that a thickness of a respective area of the first and second base electrodes 31a and 32a corresponding to a virtual line drawn in a length direction of the ceramic body 10 from the uppermost internal electrode among the first and second internal electrodes 21 and 22 is ta, 10 μm≦ta≦50 μm may be satisfied to prevent moisture or a plating solution from being infiltrated.

For example, a thickness tc of the upper and lower cover layers may be decreased, an ESL may be decreased, and the thicknesses of the areas of the first and second base electrodes 31a and 32a may be adjusted to prevent moisture or a plating solution from being infiltrated, such that the multilayer ceramic electronic component embedded in the board having excellent reliability may be implemented.

In the case in which the thickness ta of areas of the first and second base electrodes 31a and 32a corresponding to the virtual line drawn in the length direction of the ceramic body 10 from the uppermost internal electrode among the first and second internal electrodes 21 and 22 is less than 10 μm, moisture or a plating solution may be infiltrated into the electrodes, such that a problem in reliability may occur.

In the case in which the thickness ta of areas of the first and second base electrodes 31a and 32a corresponding to the virtual line drawn in the length direction of the ceramic body 10 from the uppermost internal electrode among the first and second internal electrodes 21 and 22 is greater than 50 μm, space in which capacitance may be implemented may be decreased, such that there may be difficulties in obtaining an electronic component having relatively high capacitance.

In addition, in the case in which the thickness of the dielectric layer is relatively thin in order to achieve the electronic component having relatively high capacitance, reliability may be deteriorated.

Meanwhile, in the case that the thickness of the first and second terminal electrodes 31b and 32b is tp, tp≧5 μm may be satisfied.

The thickness tp of the first and second terminal electrodes 31b and 32b may satisfy tp≧5 μm, but the present disclosure is not limited thereto, and the thickness tp of the first and second terminal electrodes 31b and 32b may be 15 μm or less.

The thickness tp of the first and second terminal electrodes 31b and 32b satisfies tp≧5 μm and is adjusted to be 15 μm or less as described above, such that a via process in the board may be excellent and the multilayer ceramic capacitor having excellent reliability may be achieved.

In the case in which the thickness tp of the first and second terminal electrodes 31b and 32b is less than 5 μm, at the time of allowing the multilayer ceramic electronic component to be embedded in the printed circuit board and processing the conductive via hole, a defect in that the conductive via hole is connected to the ceramic body 10 may occur.

In the case in which the thickness tp of the first and second terminal electrodes 31b and 32b is greater than 15 μm, cracks may be generated in the ceramic body 10 due to stress of the first and second terminal electrodes 31b and 32b.

Meanwhile, referring to FIGS. 2 and 3, in the multilayer ceramic electronic component according to the exemplary embodiment of the present disclosure, in the case that surface roughness of the first and second terminal electrodes 31b and 32b is Ra and the thickness of the first and second terminal electrodes 31b and 32b is tp, 200 nm≦Ra≦tp may be satisfied.

The surface roughness Ra of the first and second terminal electrodes 31b and 32b is adjusted to satisfy 200 nm≦Ra≦tp, such that a delamination phenomenon between the multilayer ceramic electronic component and the board may be decreased and occurrence of cracks may be prevented.

Surface roughness indicates a degree of a fine prominence-depression formed in a surface at the time of processing a metal surface.

Surface roughness is formed by tools used in a propriety process of a processing method, scratches in the surface thereof, rust, and the like. In the case of the surface roughness indicating a degree of roughness, the surface is cut by a plane perpendicular thereto and a cut cross section thereof has some curve, wherein a height from the lowest to the highest points of the curve refers to centerline average roughness and may be represented by Ra.

In the exemplary embodiment of the present disclosure, the centerline average roughness of the first and second terminal electrodes 31b and 32b is defined as Ra.

In detail, the centerline average roughness Ra of the first and second terminal electrodes 31b and 32b may be calculated by drawing a virtual center line with respect to roughness formed on one surface of the first and second terminal electrodes 31b and 32b.

Next, each distance (for example, r₁, r₂, r₃, . . . and r₁₃) may be measured based on the virtual center line of roughness, and then, the centerline average roughness Ra of the first and second terminal electrodes 31b and 32b may be calculated by calculating an average value of distances as described in the following equation:

$${R}_{a} = \frac{\vert {r}_{1} \vert + \vert {r}_{2} \vert + \vert {r}_{3} \vert + … \vert {r}_{n} \vert}{n}$$

The centerline average roughness Ra of the first and second terminal electrodes 31b and 32b is adjusted to satisfy 200 nm≦Ra≦tp, such that the multilayer ceramic electronic component having excellent withstand voltage, improved adhesion between the multilayer ceramic electronic component and the board, and excellent reliability may be achieved.

In the case in which the surface roughness of the first and second terminal electrodes 31b and 32b is less than 200 nm, a delamination phenomenon between the multilayer ceramic electronic component and the board may occur.

Meanwhile, in the case in which the surface roughness of the first and second terminal electrodes 31b and 32b exceeds the thickness tp of the first and second terminal electrodes 31b and 32b, the cracks may occur.

According to the exemplary embodiment of the present disclosure, the ceramic body 10 may include a marking part (not shown) formed on an upper surface thereof.

The ceramic body 10 includes the marking part formed thereon as described above, such that at the time of allowing the multilayer ceramic capacitor to be embedded in the board, a portion of the upper cover layer having a further reduced thickness may be disposed to be adjacent to the application processor (AP), whereby the current path may be shorten to decrease an ESL.

For example, the position of the internal electrodes of the multilayer ceramic electronic component embedded in the board is adjacent to the AP, such that the current path may be shorten to decrease an ESL.

Hereinafter, a manufacturing method of the multilayer ceramic electronic component embedded in the board according to the exemplary embodiment of the present disclosure will be described, but the present disclosure is not limited thereto.

In the manufacturing method of the multilayer ceramic electronic component embedded in the board according to the exemplary embodiment of the present disclosure, first, a slurry containing a powder such as a barium titanate (BaTiO₃) powder, or the like, may be applied to and dried on a carrier film to prepare a plurality of ceramic green sheets, thereby forming a dielectric layer.

The ceramic green sheet may be manufactured by mixing a ceramic powder, a binder, a solvent to prepare a slurry, and forming the thus obtained slurry as a sheet, the ceramic green sheet having a thickness of several μm by a doctor blade method.

Then, a conductive paste for an internal electrode including 40 to 50 parts by weight of a nickel powder having an average particle size of 0.1 to 0.2 μm may be prepared.

After the conductive paste for an internal electrode is applied to the green sheet by a screen printing method to form the internal electrode, 400 to 500 layers of the green sheets having the internal electrodes formed thereon may be stacked to form the ceramic body 10.

In the multilayer ceramic capacitor according to the exemplary embodiment of the present disclosure, the first and second internal electrodes 21 and 22 may be formed to be exposed through both end surfaces of the ceramic body 10, respectively.

Then, the first base electrode and the second base electrode including a first conductive metal and the glass may be formed on ends of the ceramic body 10.

The first conductive metal is not particularly limited, but may be at least one selected from a group consisting of copper (Cu), silver (Ag), nickel (Ni), and alloys thereof.

The glass is not particularly limited, but a material having the same composition as glass used in forming an external electrode of a general multilayer ceramic capacitor may be used for the glass.

The first and second base electrodes may be formed on ends of the ceramic body, to thereby be electrically connected to the first and second internal electrodes, respectively.

Then, the first and second base electrodes may include a plating layer formed of a second conductive metal formed thereon.

The second conductive metal is not particularly limited, but may be copper (Cu).

The plating layer may be configured of first and second terminal electrodes.

A description of other parts having the same features as those of the multilayer ceramic electronic components embedded in the board according to the foregoing exemplary embodiment of the present disclosure will be omitted.

Hereinafter, although the present disclosure will be described in detail with reference to Inventive Examples, it is not limited thereto.

Occurrence of an equivalent series inductance (ESL) and warpage depending on a thickness is of the ceramic body 10 and a ratio tc1/tc2 of a thickness tc1 of the upper cover layer to a thickness tc2 of the lower cover layer, warpage in the multilayer ceramic electronic component embedded in the board according to the inventive example of the present disclosure, was examined.

The equivalent series inductance (ESL) was determined by a relative ratio with respect to a reference equivalent series inductance (ESL₀) value.

In addition, reliability on a moisture resistance load depending on a thickness of the first and second base electrodes was examined.

Further, in order to check whether or not occurrence of a defect in a via process, depending on a thickness of the first and second terminal electrodes 31b and 32b, is present, and to check the frequency of the occurrence of delamination on an adhesion surface depending on the surface roughness of the first and second terminal electrodes 31b and 32b, the board having the multilayer ceramic electronic component embedded therein was left under a general condition of a chip component for a mobile phone mother board, for example, at a temperature of 85° C. and a relative humidity of 85%, for thirty minutes, and each examination was performed to be examined.

The following Tables 1 to 4 illustrate that an equivalent series inductance (ESL) and warpage occur depending on the thickness is of the ceramic body 10 and the ratio tc1/tc2 of the thickness tc1 of the upper cover layer to the thickness tc2 of the lower cover layer warpage.

TABLE 1

| ts (um) | tc1/tc2 | ESL/ESL₀ | Warpage | OK/NG |
|---|---|---|---|---|
| 300 | 0.03 | 0.80 | 5/200 | NG |
| | 0.05 | 0.80 | 3/200 | NG |
| | 0.08 | 0.83 | 1/200 | NG |
| | 0.11 | 0.84 | 0/200 | OK |
| | 0.14 | 0.84 | 0/200 | OK |
| | 0.18 | 0.85 | 0/200 | OK |
| | 0.21 | 0.87 | 0/200 | OK |
| | 0.25 | 0.89 | 0/200 | OK |
| | 0.29 | 0.89 | 0/200 | OK |
| | 0.33 | 0.90 | 0/200 | OK |
| | 0.38 | 0.90 | 0/200 | OK |
| | 0.43 | 0.92 | 0/200 | OK |
| | 0.48 | 0.93 | 0/200 | OK |
| | 0.54 | 0.93 | 0/200 | OK |
| | 0.60 | 0.94 | 0/200 | OK |
| | 0.67 | 0.95 | 0/200 | OK |
| | 0.74 | 0.95 | 0/200 | OK |
| | 0.82 | 0.97 | 0/200 | OK |
| | 0.90 | 0.98 | 0/200 | OK |
| | 1.00 | 1.00 | 0/200 | OK |
| | 1.11 | 1.01 | 0/200 | NG |
| | 1.22 | 1.02 | 0/200 | NG |
| | 1.35 | 1.05 | 0/200 | NG |
| | 1.50 | 1.05 | 0/200 | NG |
| | 1.67 | 1.05 | 0/200 | NG |
| | 1.86 | 1.07 | 0/200 | NG |
| | 2.08 | 1.07 | 0/200 | NG |
| | 2.33 | 1.08 | 0/200 | NG |
| | 2.64 | 1.10 | 0/200 | NG |
| | 3.00 | 1.12 | 0/200 | NG |
| | 3.44 | 1.13 | 0/200 | NG |
| | 4.00 | 1.15 | 0/200 | NG |
| | 4.71 | 1.15 | 0/200 | NG |
| | 5.67 | 1.16 | 0/200 | NG |
| | 7.00 | 1.18 | 0/200 | NG |
| | 9.00 | 1.18 | 0/200 | NG |
| | 12.33 | 1.20 | 1/200 | NG |
| | 19.00 | 1.20 | 3/200 | NG |
| | 39.00 | 1.23 | 5/200 | NG |

TABLE 2

| ts (um) | tc1/tc2 | ESL/ESL₀ | Warpage | OK/NG |
|---|---|---|---|---|
| 250 | 0.03 | 0.80 | 3/200 | NG |
| | 0.07 | 0.82 | 1/200 | NG |
| | 0.11 | 0.83 | 0/200 | OK |
| | 0.15 | 0.85 | 0/200 | OK |
| | 0.20 | 0.85 | 0/200 | OK |
| | 0.25 | 0.87 | 0/200 | OK |
| | 0.30 | 0.89 | 0/200 | OK |
| | 0.36 | 0.90 | 0/200 | OK |
| | 0.43 | 0.93 | 0/200 | OK |
| | 0.50 | 0.94 | 0/200 | OK |
| | 0.58 | 0.95 | 0/200 | OK |
| | 0.67 | 0.95 | 0/200 | OK |
| | 0.76 | 0.97 | 0/200 | OK |
| | 0.88 | 0.98 | 0/200 | OK |
| | 1.00 | 1.00 | 0/200 | OK |
| | 1.14 | 1.00 | 0/200 | NG |
| | 1.31 | 1.01 | 0/200 | NG |
| | 1.50 | 1.03 | 0/200 | NG |
| | 1.73 | 1.05 | 0/200 | NG |
| | 2.00 | 1.08 | 0/200 | NG |
| | 2.33 | 1.08 | 0/200 | NG |
| | 2.75 | 1.10 | 0/200 | NG |
| | 3.29 | 1.12 | 0/200 | NG |
| | 4.00 | 1.15 | 0/200 | NG |
| | 5.00 | 1.15 | 0/200 | NG |
| | 6.50 | 1.17 | 0/200 | NG |
| | 9.00 | 1.18 | 0/200 | NG |
| | 14.00 | 1.18 | 1/200 | NG |
| | 29.00 | 1.21 | 3/200 | NG |

TABLE 3

| ts (um) | tc1/tc2 | ESL/ESL₀ | Warpage | OK/NG |
|---|---|---|---|---|
| 200 | 0.05 | 0.82 | 1/200 | NG |
| | 0.11 | 0.85 | 0/200 | OK |
| | 0.18 | 0.86 | 0/200 | OK |
| | 0.25 | 0.88 | 0/200 | OK |
| | 0.33 | 0.91 | 0/200 | OK |
| | 0.43 | 0.93 | 0/200 | OK |
| | 0.54 | 0.95 | 0/200 | OK |
| | 0.67 | 0.97 | 0/200 | OK |
| | 0.82 | 0.97 | 0/200 | OK |
| | 1.00 | 1.00 | 0/200 | OK |
| | 1.22 | 1.02 | 0/200 | OK |
| | 1.50 | 1.02 | 0/200 | OK |
| | 1.86 | 1.05 | 0/200 | NG |
| | 2.33 | 1.06 | 0/200 | NG |
| | 3.00 | 1.06 | 0/200 | NG |
| | 4.00 | 1.08 | 0/200 | NG |
| | 5.67 | 1.11 | 0/200 | NG |
| | 9.00 | 1.13 | 0/200 | NG |
| | 19.00 | 1.16 | 1/200 | NG |

TABLE 4

| ts (um) | tc1/tc2 | ESL/ESL₀ | Warpage | OK/NG |
|---|---|---|---|---|
| 150 | 0.11 | 0.83 | 0/200 | OK |
| | 0.25 | 0.87 | 0/200 | OK |
| | 0.43 | 0.92 | 0/200 | OK |
| | 0.67 | 0.98 | 0/200 | OK |
| | 1.00 | 1.00 | 0/200 | OK |
| | 1.50 | 1.08 | 0/200 | NG |
| | 2.33 | 1.13 | 0/200 | NG |
| | 4.00 | 1.18 | 0/200 | NG |
| | 9.00 | 1.20 | 0/200 | NG |
| 100 | 0.20 | 0.89 | 0/200 | OK |
| | 0.50 | 0.95 | 0/200 | OK |
| | 1.00 | 1.00 | 0/200 | OK |
| | 2.00 | 1.05 | 0/200 | NG |
| | 5.00 | 1.10 | 0/200 | NG |

It may be appreciated from Tables 1 to 4 above that in the case in which the ratio tc1/tc2 of the thickness tc1 of the upper cover layer to the thickness tc2 of the lower cover layer in respective samples in which the ceramic bodies 10 have the thickness is of 300 μm, 250 μm, 200 μm, 150 μm, and 100 μm, respectively, satisfies a numerical range according to the exemplary embodiment of the present disclosure, the equivalent series inductance (ESL) is relatively low and the warpage does not occur.

Meanwhile, it may be appreciated that in the case in which the ratio tc1/tc2 of the thickness tc1 of the upper cover layer to the thickness tc2 of the lower cover layer is less than 0.10, the warpage occurred and in the case in which the ratio thereof is more than 1.0, the ESL was relatively high.

The following Table 5 illustrates reliability on moisture resistance load according to the thickness of the first and second base electrodes in the case in which the ratio tc1/tc2 of the thickness tc1 of the upper cover layer to the thickness tc2 of the lower cover layer satisfies the numerical range according to the exemplary embodiment of the present disclosure.

TABLE 5

| Thickness of Base | Reliability on Moisture |
|---|---|
| Electrode (ta) [μm] | Resistance Load Determination |
| 7 | X |
| 7 | X |
| 7 | X |
| 7 | X |
| 7 | X |
| 7 | X |
| 7 | X |
| 7 | X |
| 10 | ◯ |
| 10 | ⊚ |
| 10 | ⊚ |
| 10 | ⊚ |
| 10 | ⊚ |
| 10 | ⊚ |
| 10 | ⊚ |
| 15 | ◯ |
| 15 | ⊚ |
| 15 | ⊚ |
| 15 | ⊚ |
| 15 | ⊚ |
| 15 | ⊚ |
| 15 | ⊚ |

X: Defective Rate of 50% or more
Δ: Defective Rate of 10% to 50%
◯: Defective Rate of 0.01% to 10%
⊚: Defective Rate less than 0.01%

It may be appreciated from Table 5 above that in the case in which the ratio tc1/tc2 of the thickness tc1 of the upper cover layer to the thickness tc2 of the lower cover layer satisfies the numerical range according to the exemplary embodiment of the present disclosure, when the first and second base electrodes have the thickness of 10 μm or more, the reliability on a moisture resistance load is excellent, but when the first and second base electrodes have the thickness less than 10 μm, the reliability on a moisture resistance load is deteriorated.

The following Table 6 illustrates whether or not a defect in the via process according to a thickness of the first and second terminal electrodes 31b and 32b occurs.

TABLE 6

| Thickness (μm) of First | |
|---|---|
| and Second Terminal Electrodes | Determination |
| Less than 1 | X |
| 1~2 | X |
| 2~3 | X |
| 3~4 | Δ |
| 4~5 | ◯ |
| 5~6 | ⊚ |
| 6 or more | ⊚ |

X: Defective Rate of 50% or more
Δ: Defective Rate of 10% to 50%
◯: Defective Rate of 0.01% to 10%
⊚: Defective Rate less than 0.01%

It may be appreciated from Table 6 above that in the case in which the first and second terminal electrodes 31b and 32b have the thickness of 5 μm or more, via processing in the board is excellent and the multilayer ceramic capacitor having excellent reliability may be achieved.

Meanwhile, it may be appreciated that in the case in which the first and second terminal electrodes 31b and 32b have the thickness less than 5 μm, defect may occur at the time of performing the via processing in the board.

The following Table 7 illustrates whether or not the frequency of the occurrence of delamination on the adhesion surface according to a surface roughness of the first and second terminal electrodes 31b and 32b is provided.

TABLE 7

| Surface Roughness (nm) of First | |
|---|---|
| and Second Terminal Electrodes | Determination |
| Less than 50 | X |
| 50~100 | X |
| 100~150 | Δ |
| 150~200 | ◯ |
| 200~250 | ⊚ |
| 250 or more | ⊚ |

X: Defective Rate of 50% or more
Δ: Defective Rate of 10% to 50%
◯: Defective Rate of 0.01% to 10%
⊚: Defective Rate less than 0.01%

It may be appreciated from Table 7 above that in the case in which the first and second terminal electrodes 31b and 32b have the surface roughness of 200 nm or more, the frequency of the occurrence of delamination on the adhesion surface is relatively low, such that the multilayer ceramic capacitor having excellent reliability may be achieved.

Meanwhile, it may be appreciated that in the case in which the first and second terminal electrodes 31b and 32b have the surface roughness less than 200 nm, the frequency of the occurrence of delamination on the adhesion surface is increased, such that the multilayer ceramic capacitor may have a problem in terms of reliability.

### Printed Circuit Board Having Multilayer Ceramic Electronic Component Embedded Therein

FIG. 4 is a cross-sectional view showing a printed circuit board having a multilayer ceramic electronic component embedded therein according to an exemplary embodiment of the present disclosure.

Referring to FIG. 4, the printed circuit board 100 having the multilayer ceramic electronic component embedded therein according to the exemplary embodiment of the present disclosure may include: an insulating board 110; and a multilayer ceramic electronic component embedded in a board, including a ceramic body 10 including dielectric layers 11 and having first and second main surfaces opposing each other, first and second side surfaces opposing each other, and first and second end surfaces opposing each other; an active layer including a plurality of first and second internal electrodes 21 and 22 formed to be alternately exposed through both end surfaces of the ceramic body 10, having the dielectric layer 11 therebetween, to thereby form capacitance therein; upper and lower cover layers formed on upper and lower portions of the active layer; and first and second external electrodes 31 and 32 formed on both ends of the ceramic body 10, wherein the first external electrode 31 includes a first base electrode 31a and a first terminal electrode 31b formed on the first base electrode 31a, the second external electrode 32 includes a second base electrode 32a and a second terminal electrode 32b formed on the second base electrode 32a, and in the case that a thickness of the upper cover layer is tc1 and a thickness of the lower cover layer is tc2, 0.10≦tc1/tc2≦1.00 is satisfied.

The insulating board 110 is formed to have a structure in which the insulating layer 120 is included, and as shown in FIG. 4, may include conductive patterns 130 and conductive via holes 140 configuring various shapes of interlayer circuits. The insulating board 110 may be the printed circuit board 100 including the multilayer ceramic electronic component embedded therein.

After the multilayer ceramic electronic component is inserted into the printed circuit board 100, the multilayer ceramic electronic component and the printed circuit board are subjected to various severe processes during a post process such as a heat treatment of the printed circuit board 100 under the same process environment.

In particular, shrinkage and expansion of the printed circuit board 100 in the heat treatment process may be directly delivered to the multilayer ceramic electronic component inserted in the printed circuit board 100, applying stress to the adhesion surface between the multilayer ceramic electronic component and the printed circuit board 100.

In the case in which the stress applied to the adhesion surface between the multilayer ceramic electronic component and the printed circuit board 100 is greater than adhesion strength, a defect such as delamination in which adhesion surfaces thereof are detached from each other may occur.

Adhesion strength between the multilayer ceramic electronic component and the printed circuit board 100 is in proportion to electrochemical bonding strength between the multilayer ceramic electronic component and the printed circuit board 100 and an effective surface area of the adhesion surface, wherein in order to improve the effective surface area of the adhesion surface between the multilayer ceramic electronic component and the printed circuit board 100, the surface roughness of the multilayer ceramic electronic component may be adjusted to decrease the delamination phenomenon between the multilayer ceramic electronic component and the printed circuit board 100.

In addition, the frequency of the occurrence of delamination on the adhesion surface with the printed circuit board 100 according to the surface roughness of the multilayer ceramic electronic component embedded in the printed circuit board 100 may be confirmed.

Further, in the multilayer ceramic electronic component embedded in the board, in the case that the thickness of the upper cover layer is tc1 and the thickness of the lower cover layer is tc2, 0.10≦tc1/tc2≦1.00 may be satisfied to shorten the current path therein, thereby decreasing an equivalent series inductance (ESL).

Since other parts have the same features as those of the printed circuit board having multilayer ceramic electronic components embedded therein according to the foregoing exemplary embodiment of the present disclosure, a description of the overlapped parts thereof will be omitted.

As set forth above, according to exemplary embodiments of the present disclosure, thicknesses of upper and lower cover layers and thicknesses of external electrodes in a multilayer ceramic electronic component embedded in a board may be adjusted to shorten a current path, thereby decreasing equivalent series inductance (ESL).

In addition, thicknesses of external electrodes may be adjusted to implement a multilayer ceramic electronic component embedded in a board, having excellent reliability.

Further, according to exemplary embodiments of the present disclosure, relatively low inductance may be achieved and surface roughness of a plating layer may be adjusted to have improved adhesion properties capable of decreasing a delamination phenomenon between a multilayer ceramic electronic component and a board.

While exemplary embodiments have been shown and described above, it will be apparent to those skilled in the art that modifications and variations could be made without departing from the spirit and scope of the present disclosure as defined by the appended claims.

What is claimed is:

1. A multilayer ceramic electronic component embedded in a board, comprising:
a ceramic body including dielectric layers and having first and second main surfaces opposing each other, first and second side surfaces opposing each other, and first and second end surfaces opposing each other;
an active layer including a plurality of first and second internal electrodes formed to be alternately exposed through both end surfaces of the ceramic body, having the dielectric layer therebetween, to thereby form capacitance therein;
upper and lower cover layers formed on upper and lower portions of the active layer; and
first and second external electrodes formed on both ends of the ceramic body,
wherein the first external electrode includes a first base electrode and a first terminal electrode formed on the first base electrode, the second external electrode includes a second base electrode and a second terminal electrode formed on the second base electrode, and in the case that a thickness of the upper cover layer is tc1 and a thickness of the lower cover layer is tc2, 0.10≦tc1/tc2≦1.00 is satisfied.

2. The multilayer ceramic electronic component embedded in a board of claim 1, wherein in the case that a thickness of areas of the first and second base electrodes corresponding to a virtual line drawn in a length direction of the ceramic body from an uppermost internal electrode among the first and second internal electrodes is ta, 10 μm≦ta≦50 μm is satisfied.

3. The multilayer ceramic electronic component embedded in a board of claim 1, wherein the first and second terminal electrodes are formed of copper (Cu).

4. The multilayer ceramic electronic component embedded in a board of claim 1, wherein in the case that a thickness of the first and second terminal electrodes is tp, tp≧5 μm is satisfied.

5. The multilayer ceramic electronic component embedded in a board of claim 1, wherein in the case that surface roughness of the first and second terminal electrodes is Ra and a thickness of the first and second terminal electrodes is tp, 200 nm≦Ra≦tp is satisfied.

6. The multilayer ceramic electronic component embedded in a board of claim 1, wherein the first and second terminal electrodes are formed by a plating process.

7. The multilayer ceramic electronic component embedded in a board of claim 1, wherein in the case that a thickness of the ceramic body is ts, ts≦300 μm is satisfied.

8. The multilayer ceramic electronic component embedded in a board of claim 1, further comprising a marking part formed on the ceramic body.

9. A printed circuit board having a multilayer ceramic electronic component embedded therein, comprising:
an insulating board; and
the multilayer ceramic electronic component embedded in the insulating board, including a ceramic body including dielectric layers and having first and second main surfaces opposing each other, first and second side surfaces opposing each other, and first and second end surfaces opposing each other;
an active layer including a plurality of first and second internal electrodes formed to be alternately exposed through both end surfaces of the ceramic body, having the dielectric layer therebetween, to thereby form capacitance;
upper and lower cover layers formed in upper and lower portions of the active layer; and first and second external electrodes formed in both ends of the ceramic body, wherein the first external electrode includes a first base electrode and a first terminal electrode formed on the first base electrode, the second external electrode includes a second base electrode and a second terminal electrode formed on the second base electrode, and in the case that a thickness of the upper cover layer is tc1 and a thickness of the lower cover layer is tc2, 0.10≦tc1/tc2≦1.00 is satisfied.

10. The printed circuit board having a multilayer ceramic electronic component embedded therein of claim 9, wherein in the case that a thickness of areas of the first and second base electrodes corresponding to a virtual line drawn in a length direction of the ceramic body from an uppermost internal electrode among the first and second internal electrodes is ta, 10 μm≦ta≦50 μm is satisfied.

11. The printed circuit board having a multilayer ceramic electronic component embedded therein of claim 9, wherein the first and second terminal electrodes are formed of copper (Cu).

12. The printed circuit board having a multilayer ceramic electronic component embedded therein of claim 9, wherein in the case that a thickness of the first and second terminal electrodes is tp, tp≧5 μm is satisfied.

13. The printed circuit board having a multilayer ceramic electronic component embedded therein of claim 9, wherein in the case that a surface roughness of the first and second terminal electrodes is Ra and a thickness of the first and second terminal electrodes is tp, 200 nm≦Ra≦tp is satisfied.

14. The printed circuit board having a multilayer ceramic electronic component embedded therein of claim 9, wherein the first and second terminal electrodes are formed by a plating process.

15. The printed circuit board having a multilayer ceramic electronic component embedded therein of claim 9, wherein in the case that a thickness of the ceramic body is ts, ts≦300 μm is satisfied.

16. The printed circuit board having a multilayer ceramic electronic component embedded therein of claim 9, wherein the ceramic body further includes a marking part formed thereon.
